(19) United States
(12) Patent Application Publication
(10) Pub. No.: US 2007/0260978 A1
(43) Pub. Date: Nov. 8, 2007

(54) Embedded display system and method used by the system

(75) Inventors: Zhang-hoon Oh, Suwon-si (KR); Tae-jeoung Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/606,065

(22) Filed: Nov. 30, 2006

(30) Foreign Application Priority Data
May 4, 2006 (KR) 10-2006-0040392

(51) Int. Cl. G06F 17/00

(52) U.S. Cl. 715/526; 715/517; 715/500

(57) ABSTRACT

A device and a method are provided for displaying documents in a variety of formats in one or more embedded display devices. Also provided is a custom server device which controls one or more embedded display devices to display content. The custom server device comprises a database which stores meta information required to display custom data in each of the embedded display devices, a communication unit which communicates with each of the embedded display devices, and a control unit which creates custom data to be displayed in each of the embedded display devices and layout information about the custom data from the content with reference to the meta information and transmits the data to each of the embedded display devices through the communication unit.

### CROSS-REFERENCE TO RELATED PATENT APPLICATIONS

This application claims priority from Korean Patent Application No. 10-2006-0040392, filed on May 4, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relate to an embedded display system, and more particularly, to displaying a variety of formats of documents on more than one embedded display device.

2. Description of the Related Art

A related art embedded display device has a storage device such as a memory and a flash auxiliary storage unit, both of which have limited storage capacity. Moreover, the operating capacity of its central processing unit (CPU) is also limited. When such an embedded display device includes all kinds of viewers for displaying documents of various formats, for example, when the embedded display device includes both a PowerPoint viewer to show power point documents and an Excel file viewer to show Excel spreadsheets, each viewer occupies the flash auxiliary storage unit or the CPU, which reduces the efficiency of the embedded display device.

Furthermore, a related art system in an embedded display device cannot provide interworking between a plurality of systems, which allows the same document to be displayed on a plurality of embedded display devices placed in a line.

### SUMMARY OF THE INVENTION

The present invention provide an embedded display system and a method used by the system, in which content of a variety of formats of documents is transmitted to and is displayed on an embedded display device, which does not include viewers for showing the documents.

The present invention also provide an embedded display system and a method used by the system, in which the same content is divided and displayed on a plurality of embedded display devices.

According to an aspect of the present invention, there is provided a display device which displays data received from a server, the display device comprising: a display unit; a communication unit which communicates with the server; and a control unit which receives custom data and layout information from the server through the communication unit and displays the custom data in the display unit according to the layout information.

The layout information may be created with reference to meta information of the display device.

The meta information may include at least one of a display device model name, display properties of the display device, information on a central processing unit of the display device, and graphic device interface information.

The layout information may include at least one of display color information, display position information, display start and end time information, display time interval information, and scroll information, with respect to the custom data.

The control unit may receive pages of the custom data from the server at intervals which are defined in the display time interval information.

The control unit may scroll and display the custom data according to a scroll time and a scroll vector which are defined in the scroll information.

According to another aspect of the present invention, there is provided a custom server device which controls one or more embedded display devices to display content, the custom server device comprising: a database which stores meta information required to display custom data in each of the display devices; a communication unit which communicates with each of the display devices; and a control unit which creates the custom data to be displayed in each of the display devices and layout information about the custom data from the content with reference to the meta information and transmits the created custom data and the layout information to each of the display devices through the communication unit.

The control unit may include a custom data creating unit which creates the custom data by converting the content into at least one image file.

The custom data creating unit may include a virtual printer driver which converts the content into a bitmap image file.

The control unit may further include a filtering unit which creates filtered custom data to be transmitted to the display device by dividing or resizing the image file with reference to the meta information and the layout information about the content.

The meta information may include at least one of a display device model name, display properties of the display device, information on a central processing unit of the display device, and graphic device interface information.

The filtering unit may correct colors of the divided image file with reference to the meta information in order to maintain color consistency when the custom data is displayed in a plurality of display devices.

The control unit may further include a layout unit which determines at least one of display color information, display position information, display start and end time information, display time interval information, and scroll information, with respect to the filtered custom data, and creates layout information for each of the display devices, with reference to the meta information and the layout information about the content.

According to still another aspect of the present invention, there is provided a method of displaying data received from a server, the method comprising: receiving layout information from the server; executing a custom browser in order to display custom data at a position in a screen according to the layout information; and receiving the custom data from the server and displaying the custom data in the custom browser.

According to yet another aspect of the present invention, there is provided a method of controlling one or more embedded display devices to display content, the method comprising: storing meta information required to display custom data in each of the display devices; creating the custom data to be displayed in each of the display devices and layout information about the custom data from the content with reference to the meta information; and transmitting the created custom data and layout information to each of the display devices through a communication unit.

### BRIEF DESCRIPTION OF THE DRAWINGS

The above and other aspects of the present invention will become more apparent by describing in detail exemplary embodiments thereof with reference to the attached drawings in which:

FIG. 1 is a configuration diagram of an embedded display system according to an exemplary embodiment of the present invention;

FIG. 2 is a configuration diagram of the control unit in the custom server device illustrated in FIG. 1;

FIG. 3 is a configuration diagram of an embedded display system according to another exemplary embodiment of the present invention;

FIG. 4 is a block diagram illustrating a relationship between the virtual printer driver and the broker module illustrated in FIG. 3;

FIG. 5 is a diagram illustrating information flows in the embedded display device according to an exemplary embodiment of the present invention;

FIG. 6 is a flowchart illustrating a display control method according to an exemplary embodiment of the present invention;

FIG. 7 is an operational flowchart of a virtual printer driver according to an exemplary embodiment of the present invention;

FIG. 8 is a flowchart illustrating procedures of registering custom data according to an exemplary embodiment of the present invention;

FIG. 9 is a flowchart illustrating procedures of filtering custom data according to an exemplary embodiment of the present invention;

FIG. 10 is a flowchart illustrating a display method according to an exemplary embodiment of the present invention;

FIG. 11 is a flowchart illustrating a display method according to another exemplary embodiment of the present invention; and

FIG. 12 shows examples of displaying the custom data in four embedded display devices.

### DETAILED DESCRIPTION OF EXEMPLARY EMBODIMENTS OF THE INVENTION

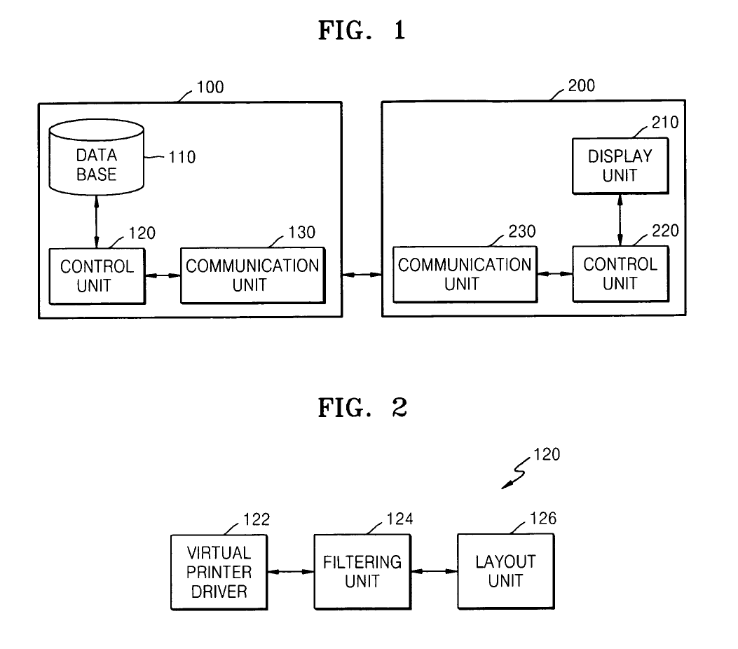

FIG. 1 is a configuration diagram of an embedded display system according to an exemplary embodiment of the present invention. Referring to FIG. 1, the embedded display system includes a custom server device 100 and one or more embedded display devices 200.

The custom server device 100 controls the embedded display devices 200 to display content and includes a database 110 which stores meta information necessary for displaying custom data in each embedded display device 200, a communication unit 130 for communicating with the embedded display devices 200, and a control unit 120 which creates the custom data and layout information about the custom data with reference to the meta information about each of the embedded display devices 200 and transmits the custom data and layout information about the custom data to each of the embedded display devices 200 through the communication unit 130.

The custom data according to an exemplary embodiment of the present invention is different from ordinary data displayed in a related art embedded display system. Here, “ordinary data” refers to data such as moving images, music, still images and the like, which are downloaded over a network and displayed in a conventional embedded display device using a viewer corresponding to the data. Moreover, the ordinary data include discovery information and the like, which is transmitted and received between the embedded display device and a server. On the contrary, the custom data, which are to be displayed besides the ordinary data, can be processed according to regulations established between the custom server and the embedded display device and are displayed through a common custom browser. According to this exemplary embodiment of the present invention, the custom data are binary image data in a bitmap format and are displayed through a custom browser for displaying bitmap images.

The embedded display device 200, which displays data received from the custom server 100, includes a display unit 210 such as a monitor, a communication unit 230 for communicating with the custom server 100, and a control unit 220 which receives the custom data and the layout information from the custom server 100 through the communication unit 230 and controls the custom browser to display the custom data in the display unit 210 according to the layout information.

FIG. 2 is a configuration diagram of the control unit 120 in the custom server 100 illustrated in FIG. 1. Referring to FIG. 2, the control unit 120 comprises a virtual printer driver 122, a filtering unit 124, and a layout unit 126.

The virtual printer driver 122 is one example of a custom data creating unit which converts content to be displayed into custom data of the present invention. Also, the virtual printer driver 122 converts content into a bitmap image file. The filtering unit 124 filters the custom data. The custom data is filtered to be transmitted to each display device by cropping or resizing the image file with reference to the meta information about each display device and content layout information which is input by a user.

The layout unit 126 creates layout information required to position the filtered custom data in a display device 200, with reference to the meta information about the display device 200 and the content layout information. The layout information for the custom data may include at least one of display color information, display location information, information about the start and end time of display, information about a display time interval on each page, and scroll information.

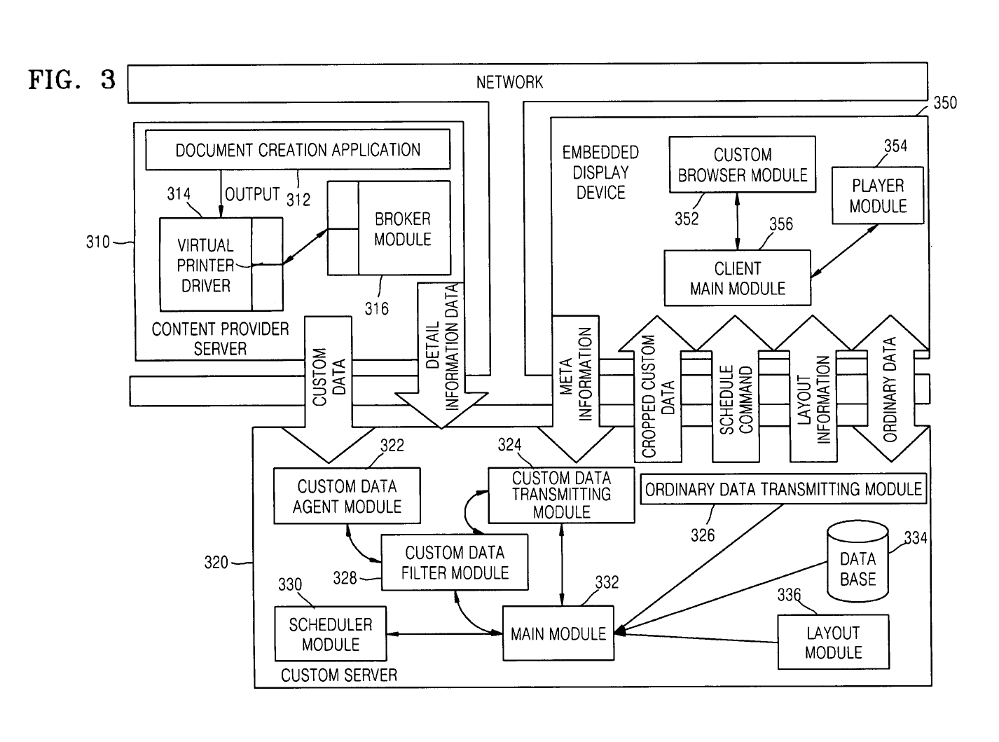

FIG. 3 is a configuration diagram of an embedded display system according to another exemplary embodiment of the present invention. Referring to FIG. 3, although a server side consists of a content provider server 310 and a custom server 320, those who are skilled in the art can obviously understand that functions of both servers can be implemented in one device such as the custom server device 100 illustrated in FIG. 1. Moreover, the embedded display system includes one or more embedded display devices 350.

The embedded display device 350 includes a processor (not shown) and the processor plays a variety of data such as moving images, picture files and the like, which are downloaded over the network. For example, the embedded display device 350 may be a multi-function monitor (MFM) or a super-sized liquid crystal display (LCD) monitor having speakers for high definition signage. A client main module 356 controls each of a plurality of modules of the embedded display device 350, which functions as a client, and transmits meta information, which is required to display custom data in the display device 350, to the custom server 320. Custom data that has been filtered and cropped in the custom server 320 is transmitted to the embedded display device 350 over the network and displayed in a custom browser module 352, which is a viewer. A player module 354 is a viewer for displaying or playing ordinary data such as moving images, music, images, etc.

The custom server 320 manages schedules for displaying the content in the embedded display device 350 and creates the custom data. A database 334 stores meta information about each of the embedded display devices 350 and playing schedules each of the embedded display devices 350. The meta information about the embedded display device 350 may include all or some of a model name of the display device 350, information about the display properties, information on the CPU, and graphic device interface information. In addition, information about the ordinary data and the meta information about the content, which includes the file location and the image size of the custom data, may be stored in the database 334. A main module 332 controls each of a plurality of modules in the custom server 320. An ordinary data transmitting module 326 transmits ordinary data files such as moving images and music to the display device 350.

The custom data is downloaded from the content provider server 310, which is a third server, over the network to a custom data agent module 322. A custom data filter module 328 crops or resizes the custom data using the layout information created by a layout module 336 and the meta information of the display device 350. A custom data transmitting module 324 transmits the custom data filtered by the custom data filter module 328 to the display device 350, which is a client. A scheduler module 330 manages a display schedule. The layout module 336 determines how to display one or more pieces of content in one or more embedded display devices 350, and determines the display location information of the pieces of content, that is, the coordinates. Moreover, the layout module 336 creates the layout information about where to arrange the custom data in the display device 350, with reference to layout information of content which has been input by a user and the meta information about the display device 350.

In the content provider server 310, word processing and printing programs such as Microsoft PowerPoint, Excel, and Word are performed. The document to be displayed in the embedded display device 350 is referred to as content. Referring to FIG. 3, although the content provider server 310 is separate from the custom server 320, those skilled in the art can obviously understand that the content provider server 310 and the custom server 320 can be integrally implemented in a single device. A document creation application 312 is a program that issues a command to print a document, and may be, for example, Microsoft Word, Huminjungum, or Internet Explorer.

A virtual printer driver 314 allows the document to be printed as an image file in a PNG, JPEG, GIF, or BMP format, etc. Furthermore, the virtual printer driver 314 receives an average color profile from a broker module 316 and uses it for printing. The average color profile is common color information of display devices that are turned on.

The broker module 316 collects information about the custom data files from the virtual printer driver 314 and transmits the information to the custom server 320. Additionally, the broker module 316 receives the average color profile of every embedded display device 350 from the custom server 320 and transmits it to the virtual printer driver 314. In FIG. 3, although the broker module 316 is included in the content provider server 310, which is a third server, it may be included in the custom server 320.

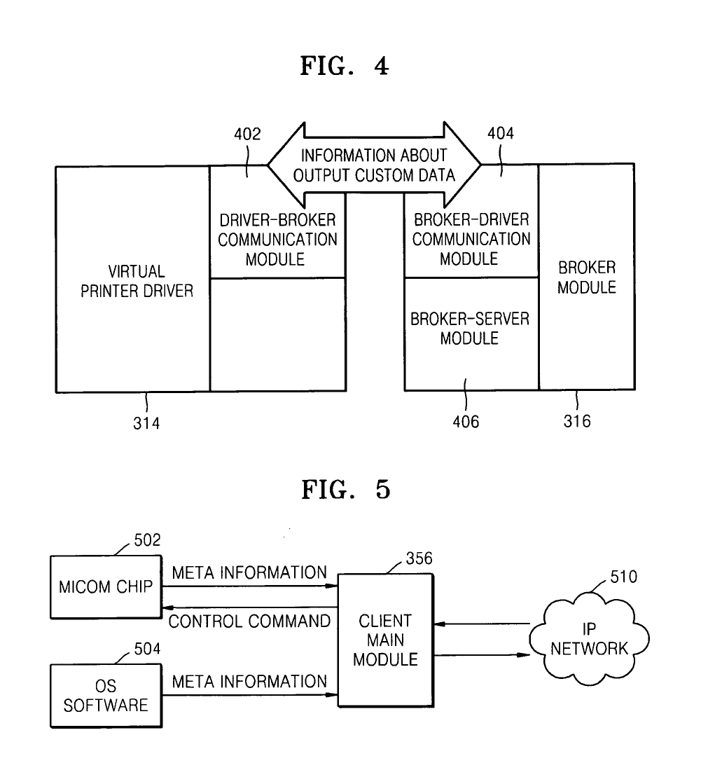

FIG. 4 is a block diagram illustrating a relationship between the virtual printer driver 314 and the broker module 316 illustrated in FIG. 3. Referring to FIG. 4, the virtual printer driver 314 may include a driver-broker communication module 402 which transmits the information about the custom data and authentication information using an interprocess communication (IPC), such as a shared memory, and a pipe. Moreover, the broker module 316 may include a broker-driver communication module 404 which allows the communication with the virtual printer driver 314 and a broker server module 406 which allows the communication with the broker module 316 and the custom data agent module 322.

FIG. 5 is a diagram illustrating information flows in an embedded display device 350 according to an exemplary embodiment of the present invention.

The client main module 356 of the embedded display device 350 transmits the meta information about the display device 350 to the custom server 320 (in FIG. 3) in advance. The meta information is acquired from a MICOM chip 502 of a monitor or operating system 504 and is transmitted to the custom server 320 over an IP network 510 or the like after being packetized. However, the network is not limited to the IP network, and other types of communication can be used.

The meta information about the embedded display device 350 includes a model name and display properties of the device 350. The model name can be acquired from the MICOM chip 502. The display properties may be resolution, frame buffer bits per pixel (BPP), gamma correction information, color profile information, brightness, contrast, and so on. The meta information may include CPU percentage measured every minute, graphic device interface (GDI) performance and capability, and GDI color profile information.

All or some of the information can be transmitted after being created as the meta information. For example, when other information can be acquired using the model name obtained from the MICOM chip 502, only the model name will be transmitted as the meta information. In this case, the custom server 320 includes a database in which the model name and the necessary display property information are stored in connection with each other, and creates the layout information necessary to display the custom data using the database.

The meta information which the client main module 356 transmits to the custom server 320 is used to display the custom data in one or more embedded display devices 350. The custom server 320 creates the layout information necessary to display the custom data using the meta information, puts it into a display command, and transmits the command to the display device 350. The client main module 356 issues a control command to the MICOM chip 502 in response to a control command such as the display command from the custom server 320. When the custom data is displayed in several display devices, the color consistency is controlled in the way described above.

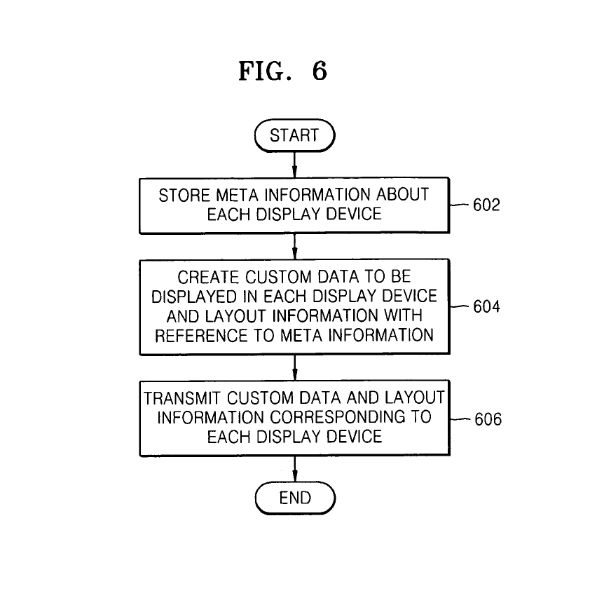

FIG. 6 is a flowchart illustrating a display control method according to an exemplary embodiment of the present invention. Referring to FIG. 6, a custom server receives and stores meta information about individual embedded display devices, which are clients for content providing service (602). As described above, the custom server may receive meta information including only a model name and control display using display property information according to the model name. Custom data to be displayed in each display device and layout information about how to display the custom data in the display device are created with reference to the meta information and layout information of content (document) input by a user (604). The created custom data and layout information are transmitted to the corresponding display device (606).

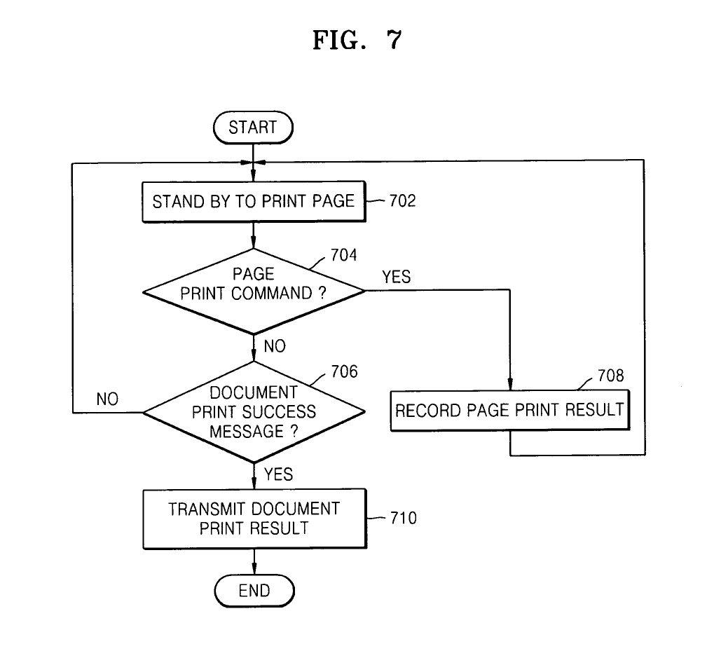

FIG. 7 is an operational flowchart of a virtual printer driver according to an exemplary embodiment of the present invention, which illustrates procedures of creating custom data from content such as a document to be displayed.

An operator of the content provider server (in FIG. 3) previously performs a program corresponding to a broker module 316 and a program (documentation creation application 312) which allows the content to be output through an ordinary printer. A desired page of the document is printed through a virtual printer driver 314. Documents in a variety of formats can be printed using operation programs with a function which allows the documents to be output to a virtual printer.

Referring to FIG. 7, the virtual printer driver 314 stands by to print a page (702) and, when receiving a message, it determines if the message indicates that the page is to be printed (704). If the message indicates that the page is to be printed, the printing result is recorded in a storage unit of the contents provider server (708). For example, bitmap data of each page is made into a bitmap file with a proper resolution and then stored. In this case, authentication information may be additionally stored. The virtual printer driver 314 stores the page and then enters a stand-by state to print (702). If the received message does not indicate that the page is to be printed, the virtual printer driver 314 determines if the message indicates that document printing has been successful, that is, if the print has been completed (706). If the message does not indicate that the document printing has been successful, the virtual printer driver 314 enters the stand-by state to print (702). If the message indicates that the document printing has been successful, the virtual printer driver 314 transmits the result of printing the pages in the document to the broker module 316 (710). To this end, a driver-broker communication module 402 (in FIG. 4) of the virtual printer driver 314 transmits a pathname list of the created bitmap files to a broker-driver communication module 404. A broker-server module 406 transmits the pathname list and information about access to the content provider server 310 to the custom server 320.

The access information is necessary for the custom server 320 to download a custom data file from the content provider server 310 through a predetermined download unit. The download unit may be an FTP, a TCP/IP socket, a serial port, or a Windows shared resource access communication, but it is not limited thereto. The configuration of the access information may differ depending on the download unit, and the access information may include an IP address of the content provider server 310, an IP port number (a port number for the FTP or socket communication), user ID and password, a pathname list of the bitmap files, etc. Moreover, in the case of serial communication, the access information may include a COM port number, information about parity, bitrate, stopbit, databit, and flowcontrol. In this exemplary embodiment of the present invention, this information is referred to as meta information.

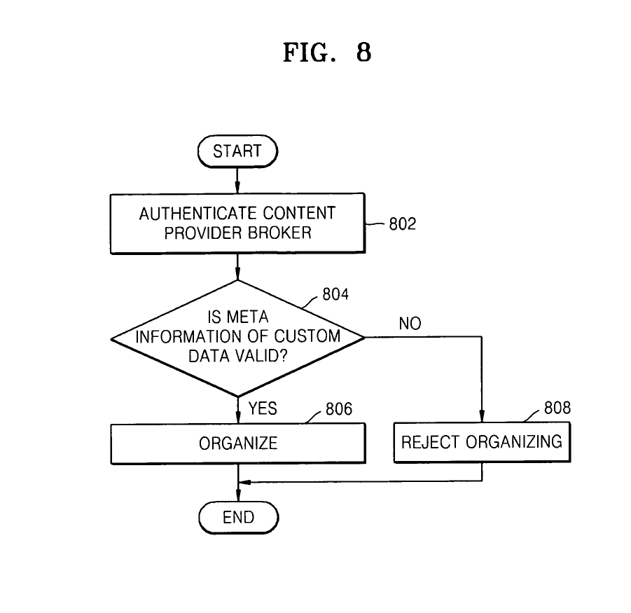

FIG. 8 is a flowchart illustrating procedures of registering custom data according to an exemplary embodiment of the present invention. A custom data agent module 322 of the custom server 320 (in FIG. 3) receives meta information about the custom data from the content provider server 310 and transmits it to a custom data filter module 328 and a main module 332.

Referring to FIG. 8, first the main module 332 authenticates a broker module 316 of the content provider server 310 (802). When the authentication succeeds, it is determined if the meta information of the custom data is valid (804). In this operation, it is determined if the custom data can be supported by a display device. When the meta information is valid, organizing is performed (806). In this operation, the content is registered by storing the meta information in a database or a memory unit. When the meta information is not valid, the organizing is rejected (808).

A user can define layout information about how to display the content and input it to the custom server. The layout information may include a display interval list which shows when each page of the custom data will be displayed and default interval information which is used when the user does not set the display interval list. In addition, the layout information may include scroll information which may be represented as a list defining the scroll distance and time (page, scroll vector, scroll time) with respect to each page. When the scroll time is not defined by the user, a default time may be used. The scroll vector may be represented as a two dimensional ordered pair which shows how much the scroll vector has to be scrolled. For example, if the scroll time is 1 and the scroll vector is (0, −10), the corresponding page is scrolled upwardly by 10 per one second. Among the meta information described above, information about GDI performance, capability and the like may used to restrict the scroll vector and the scroll time.

The user inputs information about which content is to be displayed in which display device through a layout module 336. Moreover, the user may set coordinate information about which content is to be displayed at which position and the scroll information. The layout information input by the user is stored in a memory of the custom server 320, and, if necessary, may be stored in a file or a database. The user defines schedule information about the start and end time for displaying the custom data. The defined schedule is stored in the database. Here, besides the schedule information, a name of the corresponding layout information file may be stored as a field of a table.

By the time the custom data is displayed, a scheduler module 330 performs the following operations. That is, the scheduler module 330 checks if there is a task to be performed every SCEHDULE_TIME_INTERVAL, which is a schedule check interval. If there is no task to be performed, the scheduler module 330 terminates its operation, otherwise the scheduler module 330 checks if the current time and the start time on the schedule list are the same. When performing of the task should be started, layout information about the content related to the schedule is transmitted to the display device 350 and the custom data filter module 328. The custom data filter module 328 analyses the layout information about the content, creates filtered custom data to be transmitted to each of one or more embedded display devices 350, and creates layout information about how to display the custom data in the corresponding display device 350. The scheduler module 330 removes the past schedules from the schedule list, and terminates a push state if an embedded display device is in the push state.

The custom data filter module 328 takes data from the content provider server 310 through the custom data agent module 322 at a time prior to the time for displaying the data with reference to iRawDataInterval, which is a download interval, or a time obtained by adding the time interval defined in the display interval list and the buffering time interval together. Several pieces of the custom data may be buffered at the same time. Moreover, the custom data filter module 328 creates filtered custom data by cropping it in advance and stores it as a file with reference to iUpdateInterval, which is an update interval, or a time obtained by adding the time interval defined in the display interval list and the buffering time interval together. The custom data is transmitted to one or more embedded display devices through the custom data transmitting module 324 at the time defined in the display interval list.

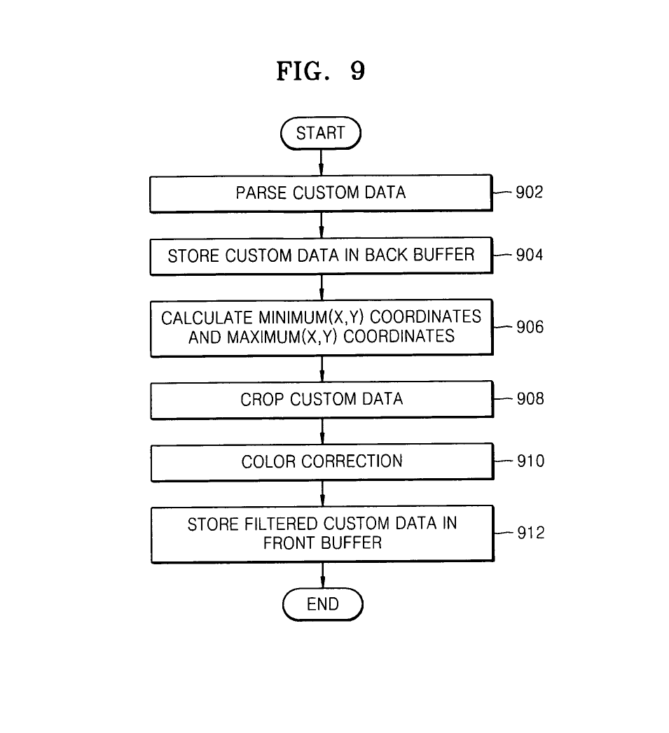

FIG. 9 is a flowchart illustrating procedures of filtering custom data according to an exemplary embodiment of the present invention. Referring to FIG. 9, a custom data filter module 328 (in FIG. 3) parses and authenticates downloaded custom data (902). When the authentication is completed, information about whether or not the authentication is performed is stored and detailed authentication information is removed. Bitmap data is stored in a back buffer for the next operation (904). The custom data filter module 328 determines which part of an image is to be transmitted to each of the embedded display devices at the next front buffer flipping point using the content layout information such as scroll vector information and schedule information, and calculates minimum(x,y) coordinates and maximum(x,y) coordinates which correspond to the maximum bitmap size (906). The bitmap data is cropped according to the coordinates (908). Colors of the cropped images are corrected using meta information about each of the display devices (910). This is to maintain the color consistency when the data are displayed in different display devices. Pieces of the filtered custom data which have been cropped and corrected with respect to the colors are stored in a front buffer (912). The front buffer is for storing custom data that will be taken by the display devices, which are clients.

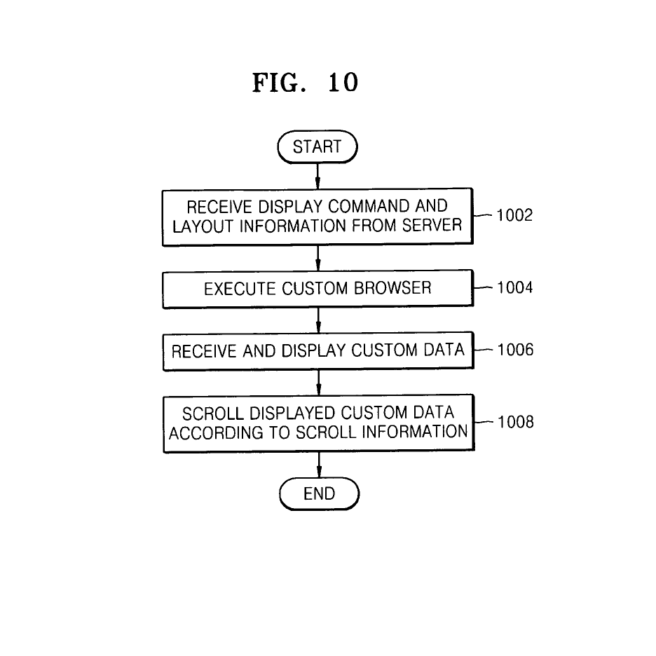

FIG. 10 is a flowchart illustrating a display method according to an exemplary embodiment of the present invention. Referring to FIG. 10, a client main module 356 (in FIG. 3) receives a control command for displaying data and layout information about custom data and ordinary data from the custom server 320 (1002). The layout information includes information about screen division. A custom browser module 352 displays the custom data at predetermined positions according to the layout information (1004). When there are more than one ordinary data and custom data to be displayed at the same time, a player module 354 and the custom browser module 352 for displaying each data displays the data in an area (coordinates) determined by the layout information. The player module 354 receives the corresponding streamed media and plays it. The custom browser module 352 receives the custom data and displays it (1006). The custom browser module 352 may receive the custom data by taking the filtered custom data stored in a front buffer of the custom server 320. When a display time interval is set in the layout information, each of pages of the custom data is received and displayed at respective display time intervals. Moreover, when the layout information includes scroll information, the displayed custom data is scrolled according to the scroll information (1008).

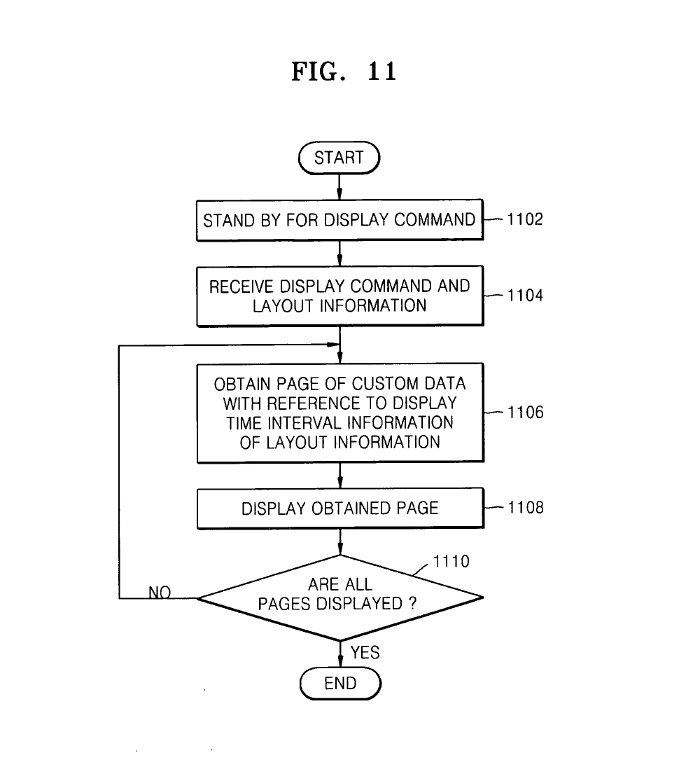

FIG. 11 is a flowchart of a display method according to another exemplary embodiment of the present invention. This exemplary embodiment relates to a display method in the case that custom data is composed of a plurality of pages. Referring to FIG. 11, a client main module 356 (in FIG. 3) stands by to receive a display command from the custom server 320 (1102), and receives layout information together with the display command (1104). A custom browser module 352 downloads each page of the custom data from a front buffer of the custom server 320 according to the display time interval when the layout information includes a display time interval, or otherwise according to a default time interval (1106). The obtained page is displayed in the custom browser module 352 (1108). When all of the pages of the custom data are displayed, the custom browser module 352 terminates its operation (1110).

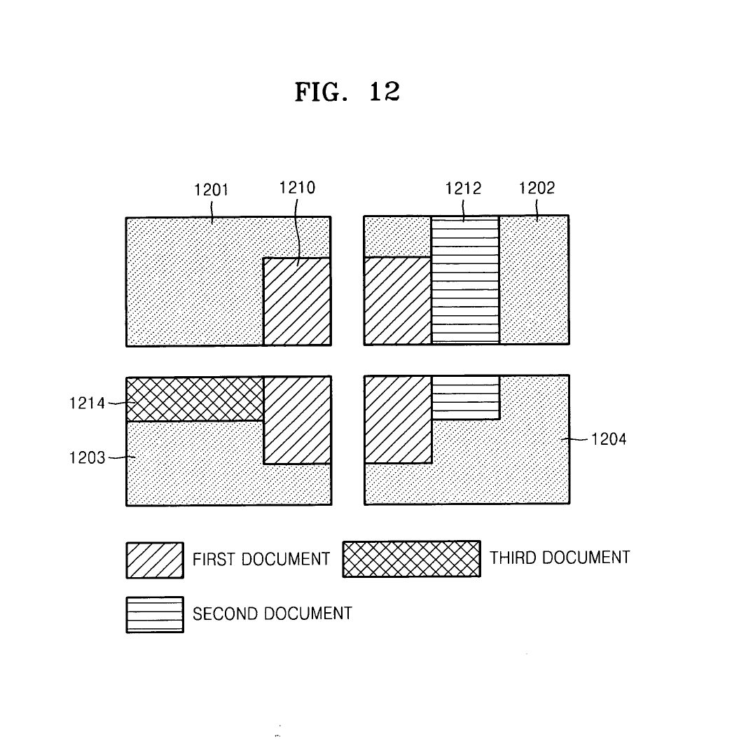

FIG. 12 shows examples of displaying custom data in four embedded display devices 1201, 1202, 1203, and 1204. Referring to FIG. 12, two pieces of custom data 1210 and 1212 and one piece of ordinary data 1214 are displayed in the four display devices 1201, 1202, 1203, and 1204. A first document 1210 is displayed over the four display devices 1201, 1202, 1203, and 1204, and a second document 1212 is displayed over two display devices 1202 and 1204. Each of the display devices 1201, 1202, 1203, and 1204 receives layout information including display position, display time, and information about the scrolling of the page and displays the custom data in the custom browser according the layout information.

The methods according to the exemplary embodiments of the present invention as described above, can also be embodied as computer readable codes on a computer readable recording medium.

According to the exemplary embodiments of the present invention, an embedded display device does not need to include a document viewer program, which allows the embedded display device to save its resources. Moreover, since a font required to perform the document viewer is not needed, storage can be saved. Furthermore, a function to connect several systems, which allows the same document to be displayed without cooperation between document viewers, in the same way as a system in which several embedded display devices are placed in a line, is provided.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A display device which displays data received from a server, the display device comprising:
a display unit;
a communication unit which communicates with the server; and
a control unit which receives custom data and layout information from the server through the communication unit and displays the custom data in the display unit according to the layout information.

2. The display device of claim 1, wherein the layout information is created with reference to meta information of the display device.

3. The display device of claim 2, wherein the meta information includes at least one of a display device model name, display properties of the display device, information on a central processing unit of the display device, and graphic device interface information.

4. The display device of claim 2, wherein the layout information includes at least one of display color information, display position information, display start and end time information, display time interval information, and scroll information, with respect to the custom data.

5. The display device of claim 4, wherein the control unit receives pages of the custom data from the server at intervals which are defined in the display time interval information.

6. The display device of claim 4, wherein the control unit scrolls and displays the custom data according to a scroll time and a scroll vector which are defined in the scroll information.

7. A custom server device which controls one or more embedded display devices to display content, the custom server device comprising:
a database which stores meta information required to display custom data in each of the embedded display devices;
a communication unit which communicates with each of the embedded display devices; and
a control unit which creates the custom data to be displayed in each of the embedded display devices and layout information about the custom data from the content with reference to the meta information and transmits the custom data and the layout information to each of the embedded display devices through the communication unit.

8. The custom server device of claim 7, wherein the control unit comprises a custom data creating unit which creates the custom data by converting the content into at least one image file.

9. The custom server device of claim 8, wherein the custom data creating unit comprises a virtual printer driver which converts the content into a bitmap image file.

10. The custom server device of claim 8, wherein the control unit further comprises a filtering unit which creates filtered custom data to be transmitted to each of the embedded display devices by dividing or resizing the image file with reference to the meta information and the layout information about the content.

11. The custom server device of claim 10, wherein the meta information comprises at least one of a display device model name, display properties of an embedded display device, information on a central processing unit of the embedded display device, and graphic device interface information.

12. The custom server device of claim 10, wherein the filtering unit corrects colors of the divided image file with reference to the meta information in order to maintain color consistency when the custom data is displayed in the embedded display devices.

13. The custom server device of claim 10, wherein the control unit further comprises a layout unit which determines at least one of display color information, display position information, display start and end time information, display time interval information, and scroll information, with respect to the filtered custom data, and creates layout information for each of the embedded display devices, with reference to the meta information and the layout information about the content.

14. A method of displaying data received from a server, the method comprising:
receiving layout information from the server;
executing a custom browser in order to display custom data at a position in a screen according to the layout information; and
receiving the custom data from the server and displaying the custom data in the custom browser.

15. The method of claim 14, further comprising:
transmitting to the server meta information of a display device necessary for displaying the custom data,
wherein the layout information is created with reference to the meta information of the display device.

16. The method of claim 15, wherein the meta information comprises at least one of a display device model name, display properties of the display device, information on a central processing unit of the display device, and graphic device interface information.

17. The method of claim 15, wherein the layout information comprises at least one of display color information, display position information, display start and end time information, display time interval information, and scroll information, with respect to the custom data.

18. The method of claim 17, further comprising:
receiving pages of the custom data from the server at intervals which are defined in the display time interval information.

19. The method of claim 17, further comprising:
scrolling the displayed custom data according to a scroll time and a scroll vector which are defined in the scroll information.

20. A computer readable recording medium storing a computer program for performing a method of displaying data received from a server, the method comprising:
receiving layout information from the server;
executing a custom browser in order to display custom data at a position in a screen according to the layout information; and
receiving the custom data from the server and displaying the custom data in the custom browser.

21. A method of controlling one or more embedded display devices to display content, the method comprising:
storing meta information required to display custom data in each of the embedded display devices;
creating the custom data to be displayed in each of the embedded display devices and layout information about the custom data from the content with reference to the meta information; and
transmitting the custom data and the layout information to each of the embedded display devices through a communication unit.

22. The method of claim 21, wherein the creating the custom data comprises converting the content into at least one image file.

23. The method of claim 22, wherein the converting the content comprises converting the content into a bitmap image file using a virtual printer driver.

24. The method of claim 22, wherein the creating the custom data further includes filtering the custom data by dividing or resizing the image file with reference to the meta information and the layout information about the content, so that the custom data can be transmitted to each of the embedded display device.

25. The method of claim 24, wherein the meta information comprises at least one of a display device model name, display properties of an embedded display device, information on a central processing unit of the embedded display device, and graphic device interface information.

26. The method of claim 24, wherein the filtering the custom data comprises correcting colors of the divided image file with reference to the meta information in order to maintain color consistency when the custom data is displayed in the embedded display devices.

27. The method of claim 24, further comprising:
creating layout information for the display device by determining at least one of display color information, display position information, display start and end time information, display time interval information, and scroll information, with respect to the filtered custom data, with reference to the meta information and the layout information about the content.

28. A computer readable recording medium storing a computer program for performing a method of controlling one or more embedded display devices to display content, the method comprising:
storing meta information required to display custom data in each of the embedded display devices;
creating the custom data to be displayed in each of the embedded display devices and layout information about the custom data from the content with reference to the meta information; and
transmitting the custom data and the layout information to each of the embedded display devices through a communication unit.
